(19) United States
(12) Patent Application Publication
(10) Pub. No.: US 2015/0232318 A1
(43) Pub. Date: Aug. 20, 2015

(54) Bottle Cap Dispenser with Re-attachable Perforated Cartridge Chamber

(71) Applicant: William Brent Meldeau, Chatsworth, CA (US)

(72) Inventor: William Brent Meldeau, Chatsworth, CA (US)

(21) Appl. No.: 14/609,243

(22) Filed: Jan. 29, 2015

Related U.S. Application Data
(60) Provisional application No. 61/940,149, filed on Feb. 14, 2014.

(51) Int. Cl. B67D 3/00; B65D 47/06

(52) U.S. Cl. CPC B67D 3/0019; B67D 3/0061; B65D 47/068

(57) ABSTRACT

A bottle cap dispenser for administering doses of soluble consumables in conjunction with a water bottle. The bottle cap dispenser includes a bottle dispensing cap and a cartridge chamber removably attached to one other. The bottle dispensing cap provides a means for attaching the bottle cap dispenser to a water bottle, while the cartridge chamber provides a receptacle for retaining the soluble consumables. The cartridge chamber is attached below the bottle dispensing cap and has a plurality of perforations, which allows water to enter the cartridge chamber and dissolve the soluble consumables. The water is then dispensed through a spout of the bottle dispensing cap. A filter assembly may also be attached to the cartridge chamber opposite the bottle dispensing cap. A filter casing is attached to the cartridge chamber, while a filter material positioned within the filter casing removes impurities and contaminants from the water.

The current application claims a priority to the U.S. Provisional Patent application Ser. No. 61/940,149 filed on Feb. 14, 2014.

### FIELD OF THE INVENTION

The present invention relates generally to water bottle accessories. More specifically, the present invention is a water bottle dispenser for retaining and dispensing doses of water soluble materials, such as supplements or medications.

### BACKGROUND OF THE INVENTION

There is a major problem with every vitamin sports drink on the market, that problem being potency. When vitamins and supplements are added to liquid, they immediately begin to start losing potency, and the longer the bottles sit around, the less potent they become. Additionally, vitamins suffer degradation when exposed to ultraviolet rays and heat. Most vitamin sports drinks utilize a hot fill process that heats up the liquid to a very high temperature in order to kill unwanted germs, bacteria, and microorganisms. However, in doing so the potency of the vitamins, electrolytes, valuable enzymes, etc. is compromised. Even when taking vitamins/supplements in pill form, the potency is not always one hundred percent as pills are sometimes not fully digested and pass through the body.

In order to maximize the potency of vitamins and supplements it is important to add the vitamins/supplements to liquid at the time of consumption. As such, twist or push to activate bottle cap supplement dispensers have been developed for mixing vitamins/supplements with liquid. However, said twist or push to activate bottle cap dispensers utilize a membrane, foil, or similar component that is pierced upon twisting or pushing down the cap in order to release the vitamins, supplements, etc. Due to the design, these twist or push to activate bottle cap dispensers are for single use and thus need to be discarded once used. The need to discard these twist or push to activate bottle cap dispensers has a large environmental impact, producing large amounts of waste. Additionally, it is also possible for residual particles from the membrane to be introduced to the liquid when releasing the vitamins/supplements, thus contaminating the beverage.

U.S. Pat. No. 7,854,104 B2 to Cronin et al discloses a method for manufacturing and assembling parts of a cap in which a cap for dispensing pre-packaged supplements is described. The cap has a fixed member that is mounted to the threaded neck of a bottle and a movable member that holds the supplements within the cap. In a retracted position the movable member is sealed against the fixed member until enough force is applied to unseat the movable member, releasing the supplements.

U.S. Patent Application Publication No. 2011/0290678 A1 to Simonian et al discloses a dispensing cap system for dispensing a supplement material through a bottle neck opening. A cap member having a storage member for internally retaining supplements is attached to a bottle neck, wherein a seal member engages the bottle neck. A cylindrical valve member is slid from a storage position is which dispensing ports are blocked, to a dispensing position in which the dispensing ports are opened, wherein the supplements come in contact with liquid in the bottle.

U.S. Pat. No. 6,926,138 B1 to Basham et al discloses a cap having a plunger with a centrally disposed cavity portion for containing an additive. The plunger traverses through a receiving member attached to a container, wherein a spring member is positioned between the cavity portion and a neck portion of the plunger, such that the cavity portion can be engaged between a down position and up position. An opening of the plunger is pressed against a membrane that extends across the opening of the container, wherein downward pressure pierces the membrane, releasing the additive.

U.S. Pat. No. 5,609,759 to Nohren et al discloses a bottle filter cap having a tube of filtering material with a substantially continuous liquid-porous side wall. The tube is connected to a cap providing means of attachment to a bottle. A valve operatively coupled to the cap is in fluid communication with the tube and is movable between a position for allowing liquid to flow through the tube and position to restrict flow through the tube.

There are currently no supplement dispensing caps that are reusable in design, allow a user to choose any desired supplement, or provide a means for filtering liquid. Therefore it is the object of the present invention to provide a bottle cap dispenser for administering doses of soluble consumables that is reusable. The present invention includes a bottle dispensing cap, a cartridge chamber, and optionally a filter assembly. The cartridge chamber is filled with the desired soluble consumables, such as vitamins, supplements, nutraceuticals, probiotics, medicine, etc., and then attached to the bottle dispensing cap. The bottle dispensing cap is then attached to a water bottle, wherein the cartridge chamber is positioned within the water bottle. Liquid within the water bottle is then able to flow through a plurality of perforations of the cartridge chamber dissolving the soluble consumables. Once the soluble consumables are dissolved in the liquid, the mixture can be dispensed through a spout of the bottle dispensing cap. The bottle dispensing cap can then be removed from the water bottle, wherein the cartridge chamber can be reloaded at another time of consumption. Not only does the present invention increase sustainability by being reusable itself and allowing a user to use the same water bottle, but the present invention also allows users to choose from a broader selection of dry supplements that are packaged and sealed separately.

### BRIEF DESCRIPTION OF THE DRAWINGS

FIG. 1 is a perspective view of the present invention having a nozzle in an open position.

FIG. 2 is a perspective view of the present invention having the nozzle in a closed position.

FIG. 3 is an exploded view of the nozzle, annular cap body, and cartridge chamber.

FIG. 4 is a perspective view of the present invention having a lid and hinge being in a closed position.

FIG. 5 is a perspective view of the present invention having the lid and hinge being in an open position.

FIG. 6 is a perspective sectional view of the bottle dispensing cap and cartridge chamber having a first attachment mechanism and a second attachment mechanism respectively, wherein the first attachment mechanism and the second attachment mechanism are a pair of opposing threads.

FIG. 7 is a front sectional view of showing the second attachment mechanism engaging the first attachment mechanism.

FIG. 8 is a perspective sectional view of the present invention, wherein the first attachment mechanism is a catch pin and the second attachment mechanism is a twist lock groove.

FIG. 9 is a perspective sectional view of the present invention, wherein the first attachment mechanism is a catch pin and the second attachment mechanism is a snap indent.

FIG. 10 is a perspective view of the present invention, wherein a filter assembly is attached to the cartridge chamber.

FIG. 11 is a perspective sectional view of the present invention with the filter assembly having a filter medium positioned within a filter casing.

FIG. 12 is a perspective view of the cartridge chamber and the filter assembly having a third attachment mechanism and a fourth attachment mechanism respectively, wherein the third attachment mechanism and the fourth attachment mechanism are a pair of opposing threads.

FIG. 13 is a perspective view of the cartridge chamber and the filter assembly, wherein the third attachment mechanism is a catch pin and the fourth attachment mechanism is a twist lock groove.

FIG. 14 is a perspective view of the cartridge chamber and the filter assembly, wherein the third attachment mechanism is a catch pin and the fourth attachment mechanism is a snap indent.

FIG. 15 is a perspective view of the present invention, wherein the bottle dispensing cap has a universal fitting clamp and a cap seal for being attached to a water bottle;

FIG. 16 is a front sectional view thereof, wherein a plurality of extrusions of the universal fitting clamp form a series of continuous horizontal ribs;

FIG. 17 is a front sectional view thereof, wherein the plurality of extrusions is staggered; and

FIG. 18 is a front sectional view thereof, wherein the plurality of extrusions form a series of continuous angled ribs.

FIG. 19 is a perspective view of the present invention, wherein the universal fitting clamp has a lateral clamp wall and a second lateral clamp wall.

FIG. 20 is a front elevational view of the present invention attached to a water bottle.

### DETAIL DESCRIPTIONS OF THE INVENTION

All illustrations of the drawings are for the purpose of describing selected versions of the present invention and are not intended to limit the scope of the present invention.

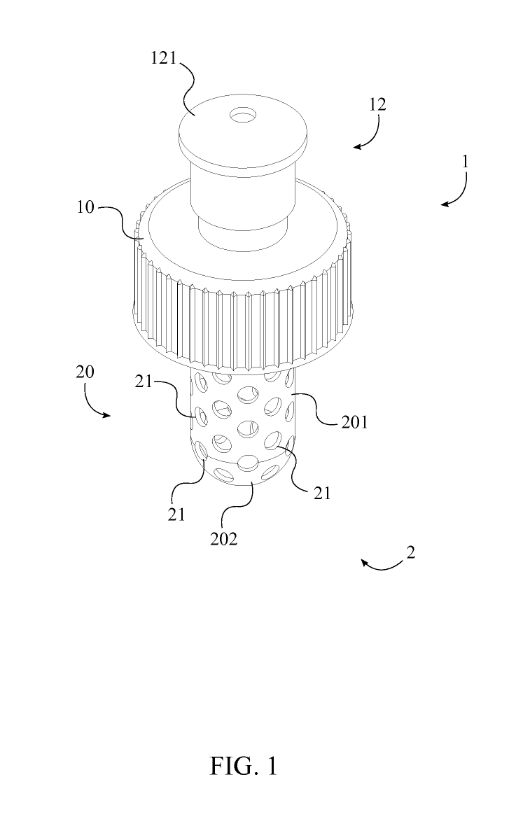

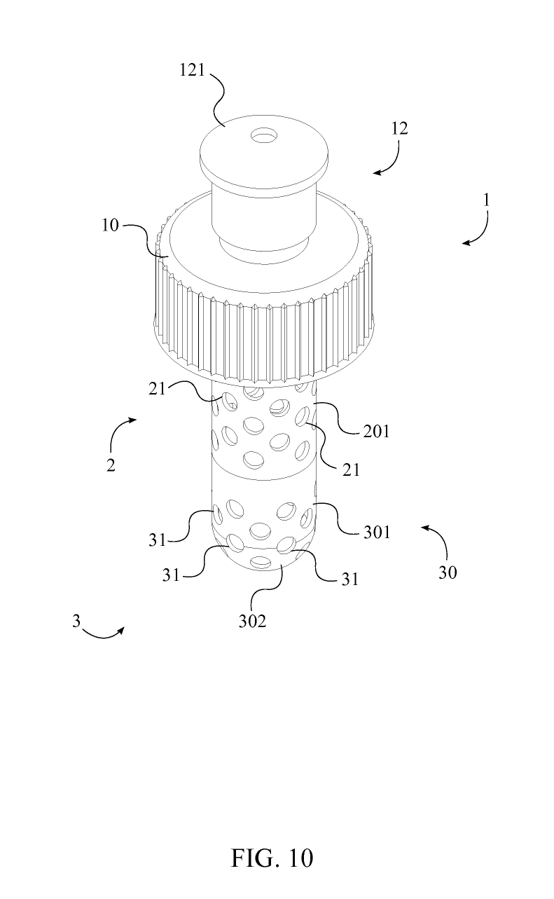

The present invention is a bottle cap dispenser for administering doses of soluble consumables, such as supplements, medications, etc., in conjunction with a water bottle or beverage bottle. The present invention is designed to be a reusable apparatus that users can fill with a desired water soluble consumable, thus reducing material waste and not limiting the users to specific brands or types of consumables to be dispensed. In reference to FIG. 1, in the preferred embodiment of the present invention, the present invention comprises a bottle dispensing cap 1 and a cartridge chamber 2. In other embodiments of the present invention, the present invention may further comprise a filter assembly 3, as shown in FIG. 10.

The bottle dispensing cap 1 provides the means for attaching the present invention to a water bottle and for dispensing liquid from the water bottle. The present invention is not limited with respect to the types of water bottles (or other beverage bottles) that the present invention can be attached to; the bottle dispensing cap 1 can be designed to be fitted onto reusable water bottles or disposable water bottles. The cartridge chamber 2 is attached to the bottle dispensing cap 1 and provides the means for retaining the soluble consumables. In embodiments where the filter assembly 3 is utilized, the filter assembly 3 is attached to the cartridge chamber 2 opposite the bottle dispensing cap 1.

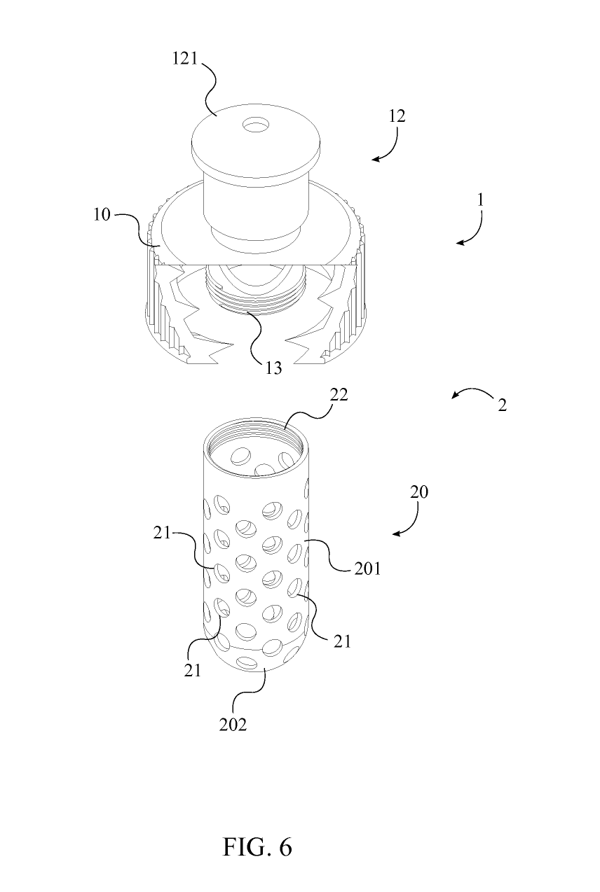

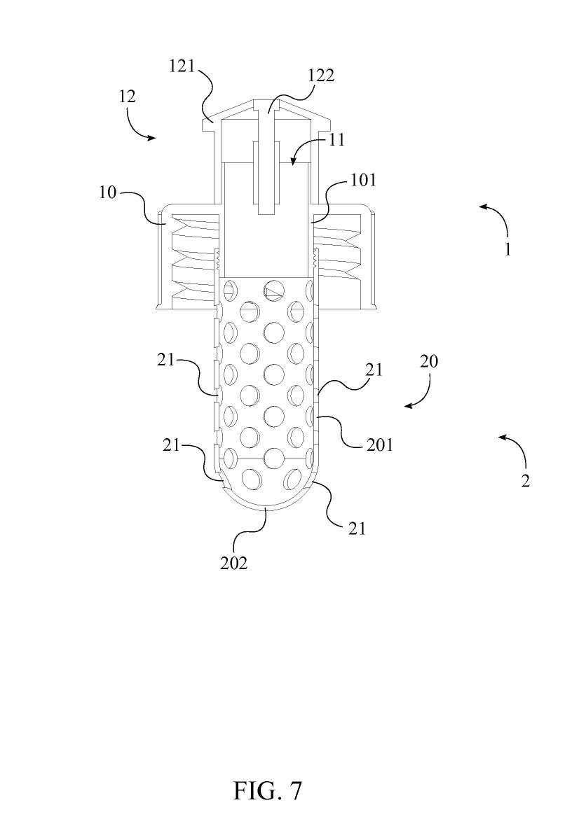

The bottle dispensing cap 1 is circular in shape, as shown in FIG. 1, such that the bottle dispensing cap 1 may be attached to the mouth of a water bottle in place of the original cap. In reference to FIG. 6-7, the bottle dispensing cap 1 comprises an annular cap body 10, a spout 11, a cap enclosure 12, a tubular extrusion 101, and a first attachment mechanism 13. The annular cap body 10 provides the means for attaching the present invention to the water bottle. The spout 11 is positioned through the annular cap body 10, while the cap enclosure 12 is positioned adjacent to the spout 11 and is adjacently connected to the annular cap body 10. Together, the annular cap body 10 and the cap enclosure 12 form a variably open-closed lid that is used to regulate fluids dispensed from the water bottle.

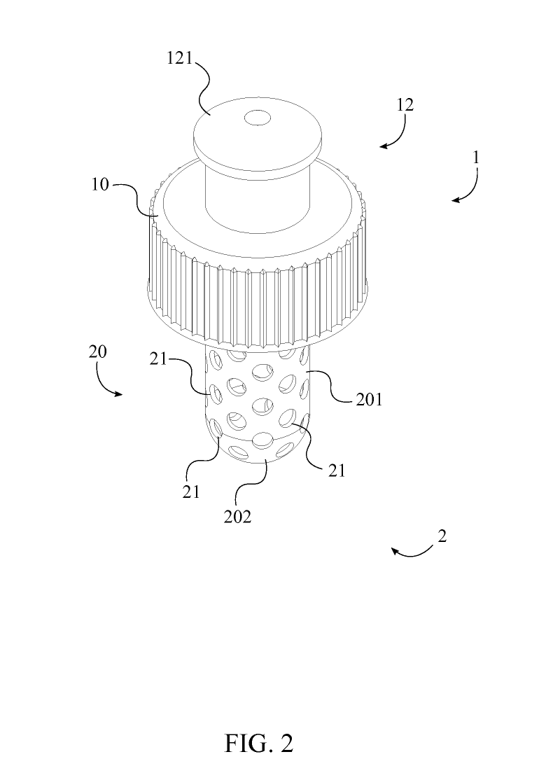

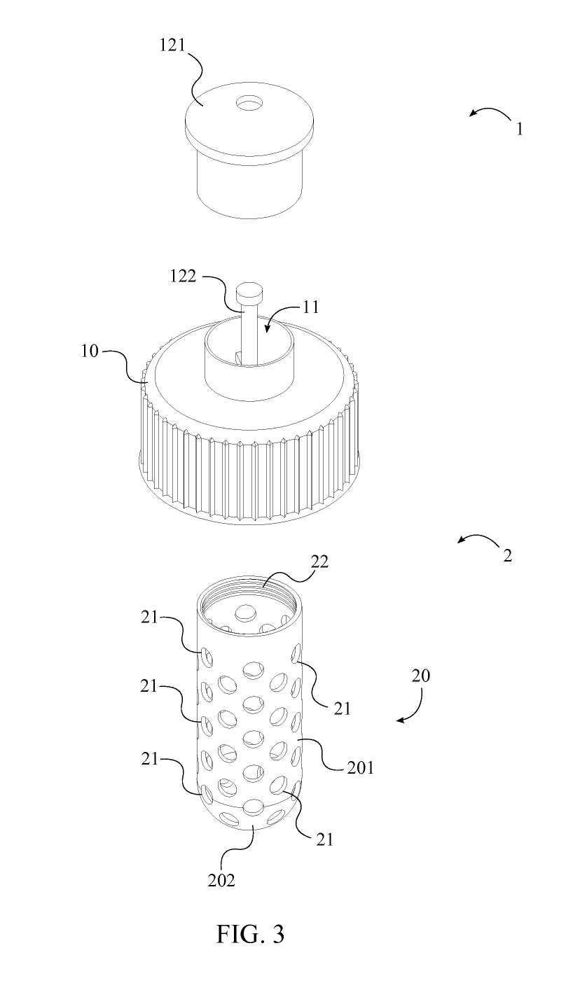

In reference to FIG. 3, in one embodiment of the present invention, the cap enclosure 12 comprises a cap shaft 122 and a nozzle 121. The cap shaft 122 is positioned adjacent to the spout 11 and is adjacently connected to the annular cap body 10 opposite the chamber body 20, and extends outwards, away from the annular cap body 10. The nozzle 121 is positioned adjacent to the annular cap body 10 opposite the chamber body 20 and is bistably connected to the cap shaft 122, wherein the nozzle 121 is in fluid communication with the spout 11. The nozzle 121 may slidably engage the cap shaft 122, such that the nozzle 121 is slid along the cap shaft 122 in order to open and close the water bottle. Alternatively, the nozzle 121 may rotatably engage the cap shaft 122, such that the nozzle 121 is turned clockwise and counterclockwise in order to open and close the water bottle. In this way, the nozzle 121 can be configured between an open position as shown in FIG. 1, and a closed position as shown in FIG. 2.

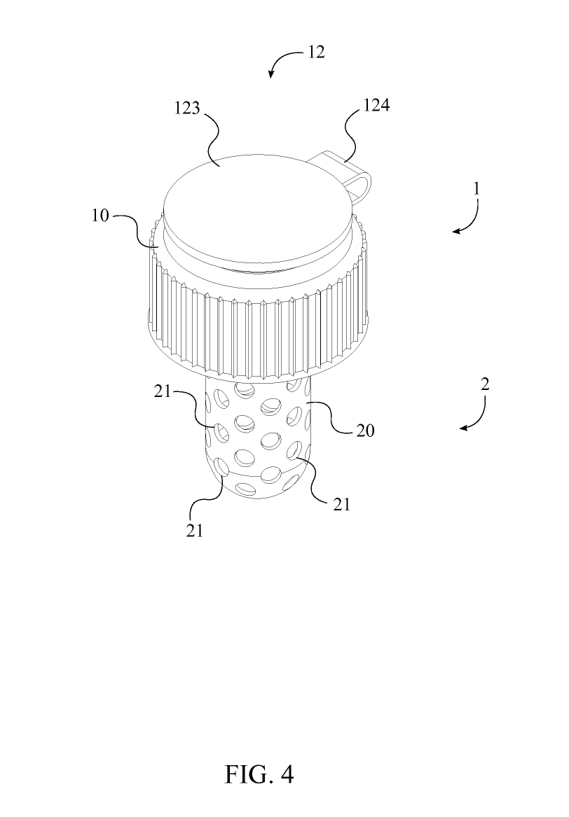

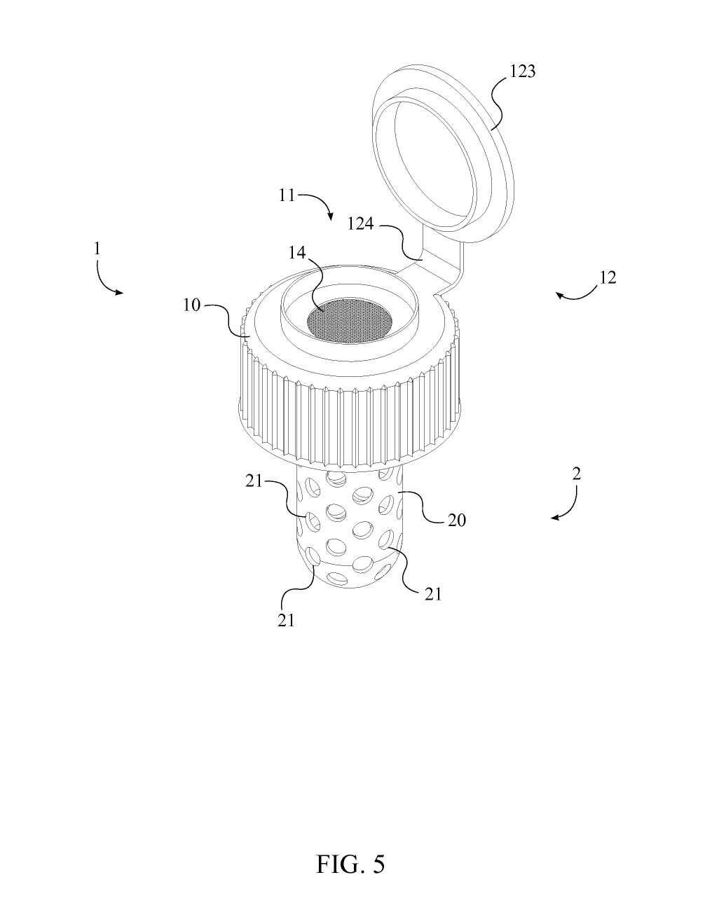

In reference to FIG. 4-5, in another embodiment of the present invention, the cap enclosure 12 comprises a lid 123 and a hinge 124, while the annular cap body 10 further comprises a screen 14. The hinge 124 is adjacently connected to the annular cap body 10, while the lid 123 is adjacently connected to the hinge 124 opposite the annular cap body 10. The lid 123 can then be made to engage the spout 11 or a lip around the spout 11, wherein the lid 123 is secured to the annular cap body 10 and seals the spout 11 closed. In this way, the lid 123 can be configured between an open position as shown in FIG. 5, and a closed position as shown in FIG. 4. The screen 14 is positioned within the annular cap body 10 in between the spout 11 and the first attachment mechanism 13, wherein the screen 14 prevents the soluble consumables from flowing out of the cartridge chamber 2 and through the spout 11. Preferably the hinge 124 is a living hinge 124, however, any other possible type of hinge 124 may be utilized.

In reference to FIG. 6-7, the first attachment mechanism 13 is integrated into the annular cap body 10 opposite the cap enclosure 12 and provides a means of attachment between the bottle dispensing cap 1 and the cartridge chamber 2. More specifically, the first attachment mechanism 13 is integrated into the tubular extrusion 101, wherein the tubular extrusion 101 is positioned within the annular cap body 10. The tubular extrusion 101 is positioned below the spout 11 when the present invention is attached to the water bottle in an upright position. Furthermore, the tubular extrusion 101 is concentrically aligned with the annular cap body 10, such that the chamber body 20 is directed through the center of the water bottle mouth.

In reference to FIG. 6, the cartridge chamber 2 is a single open ended tube that is used to retain the soluble consumables within the water bottle. The cartridge chamber 2 comprises a chamber body 20, a plurality of perforations 21, and a second attachment mechanism 22. The chamber body 20 retains the soluble consumables; the plurality of perforations 21 being positioned through the chamber body 20, such that the soluble consumables may come in contact with the contents of the water bottle. The second attachment mechanism 22 is integrated into the chamber body 20, wherein the second attachment mechanism 22 engages the first attachment mechanism in order to attach the chamber body 20 to the annular cap body 10, as shown in FIG. 7.

In further reference to FIG. 6, the chamber body 20 comprises a lateral chamber wall 201 and a chamber closure 202. The second attachment mechanism 22 is integrated into the lateral chamber wall 201, while the chamber enclosure is adjacently connected to the lateral chamber wall 201 opposite the second attachment mechanism 22. In this way, when the lateral chamber wall 201 is attached to the annular cap body 10, a restricted containment chamber is formed between the bottle dispensing cap 1 and the chamber body 20, in which the soluble consumables can be placed, as shown in FIG. 1. The plurality of perforations 21 is positioned through the lateral chamber wall 201 allowing water to flow through the chamber body 20 to the spout 11, which is in fluid communication with the chamber body 20.

The first attachment mechanism 13 and the second attachment mechanism 22 are two opposing connectors that allow the bottle dispensing cap 1 and the chamber body 20 to be attached to one another. The lateral chamber wall 201 may be positioned into or around the tubular extrusion 101 depending on the design of the present invention. As such, the first attachment mechanism 13 may be positioned about the inner surface or the outer surface of the tubular extrusion 101. Similarly, the second attachment mechanism 22 may be positioned about the inner surface or the outer surface of the lateral chamber wall 201, wherein the position of the second attachment mechanism 22 compliments the position of the first attachment mechanism about the tubular extrusion 101.

In reference to FIG. 6, in one embodiment of the present invention, the first attachment mechanism 13 and the second attachment mechanism 22 are a pair of opposing threads (i.e. one set of male threads and one set of female threads). The set of male threads can be formed by the first attachment mechanism 13, wherein the set of female threads is formed by the second attachment mechanism 22, or vice versa. In this way, the chamber body 20 is screwed onto the annular cap body 10, wherein the chamber body 20 is securely held in place.

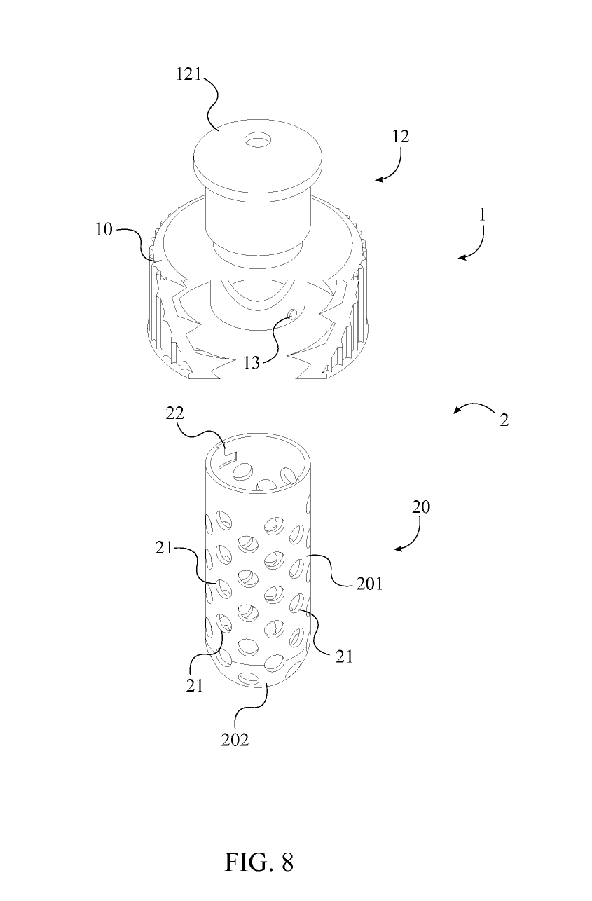

In reference to FIG. 8, in another embodiment of the present invention, the first attachment mechanism 13 and the second attachment mechanism 22 form a twist lock mechanism, wherein a catch pin and a twist lock groove are formed. The catch pin can be formed by the first attachment mechanism 13, wherein the twist lock groove is formed by the second attachment mechanism 22, or vice versa. In this way, the catch pin is slid into the twist lock groove and either the chamber body 20 or the annular cap body 10 is rotated such that the catch pin follows the twist lock groove, thus securing the cartridge chamber 2 to the bottle dispensing cap 1.

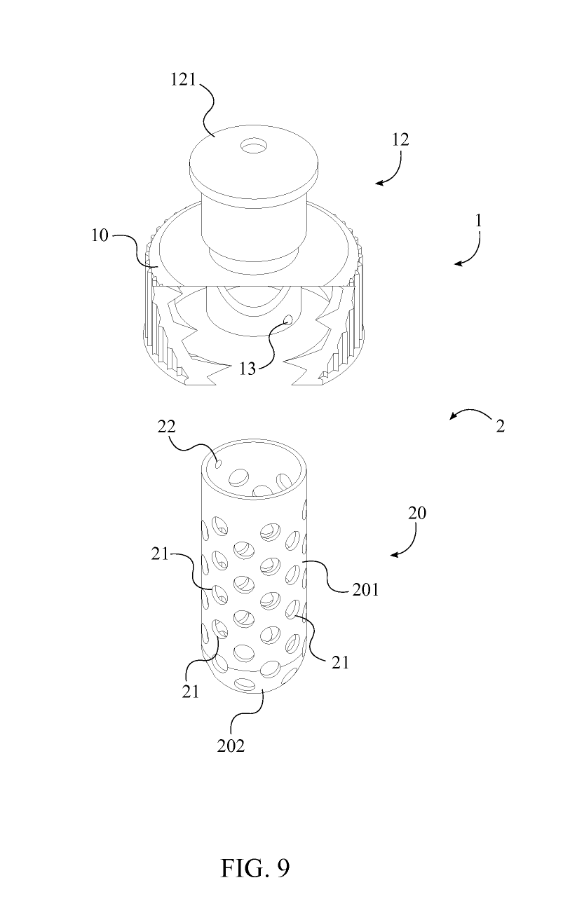

In reference to FIG. 9, in yet another embodiment of the present invention, the first attachment mechanism 13 and the second attachment mechanism 22 form a snap lock mechanism, wherein a catch pin and a snap indent are formed. The catch pin can be formed by the first attachment mechanism 13, wherein the snap indent is formed by the second attachment mechanism 22, or vice versa. In this way, as the chamber body 20 is pressed into the annular cap body 10, the catch pin engages the snap indent, thus securely holding the cartridge chamber 2 and the bottle dispensing cap 1 together.

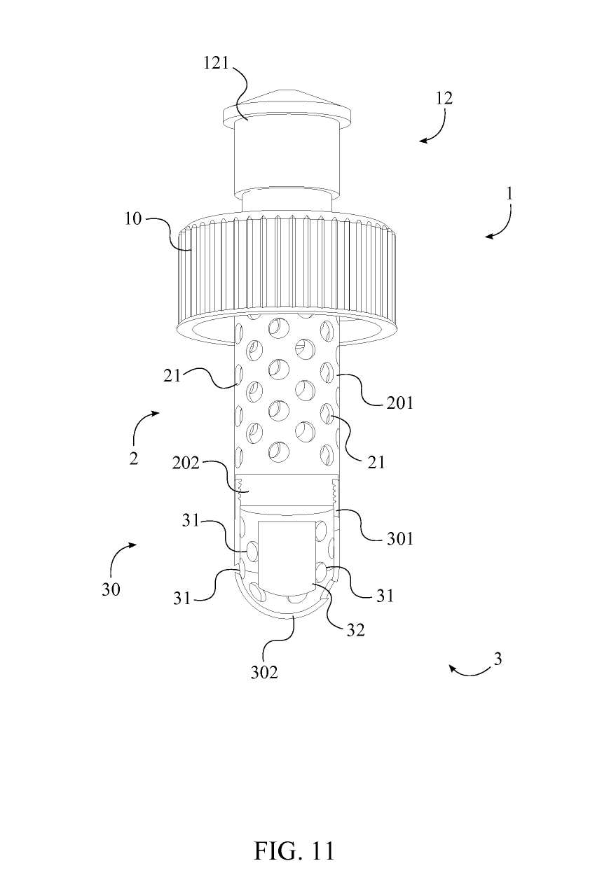

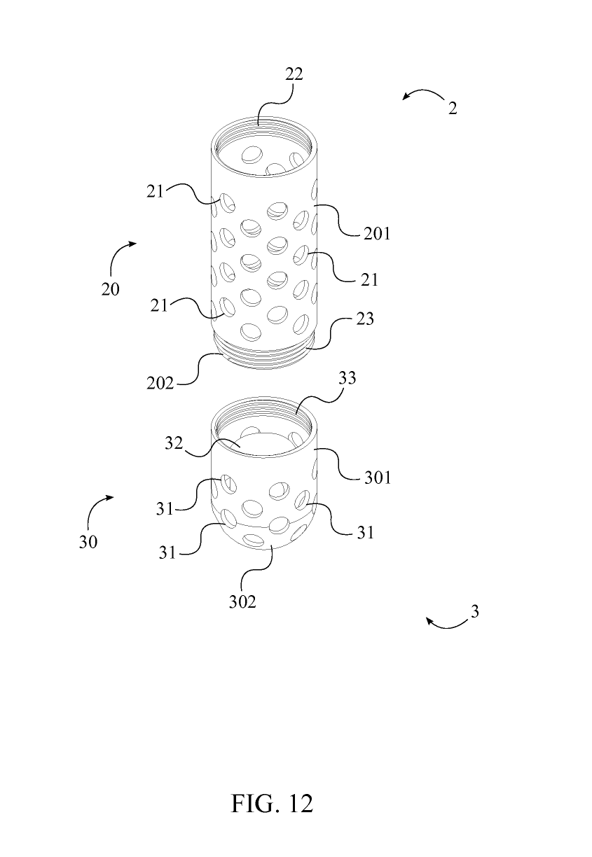

In some embodiments of the present invention, the filter assembly 3 may be utilized to remove impurities from the drinking water. In reference to FIG. 11-12, the filter assembly 3 comprises a filter casing 30, a plurality of filter holes 31, a filter medium 32, and a fourth attachment mechanism 33. The filter casing 30 is adjacently connected to the chamber body 20 opposite the annular cap body 10 as shown in FIG. 10, wherein the fourth attachment mechanism 33 is integrated into the filter casing 30. The plurality of filter holes 31 is positioned through the filter casing 30, while the filter medium 32 is positioned within the filter casing 30, thus the filter casing 30 retains the filter medium 32 while allowing the filter medium 32 to come in contact with the drinking water.

In reference to FIG. 12, the filter casing 30 comprises a lateral filter wall 301 and a filter closure 302, and is an open ended tube that is used to retain the filter medium 32 within the water bottle. The fourth attachment mechanism 33 is integrated into the lateral filter wall 301, while the filter closure 302 is adjacently connected to the lateral filter wall 301 opposite the fourth attachment mechanism 33. In this way, the filter closure 302 seals off the filter casing 30 when the filter casing 30 is attached to the chamber body 20, thus retaining the filter medium 32. The chamber body 20 further comprises a third attachment mechanism 23, wherein the third attachment mechanism 23 is integrated into the chamber body 20 opposite the second attachment mechanism 22. The fourth attachment mechanism 33 engages the third attachment mechanism 23 in order to attach the filter casing 30 to the chamber body 20, as shown in FIG. 11.

The third attachment mechanism 23 and the fourth attachment mechanism 33 are two opposing connectors that allow the chamber body 20 and the filter casing 30 to be attached to one another. The lateral filter wall 301 may be positioned into or around the chamber body 20 depending on the design of the present invention. As such, the third attachment mechanism 23 may be positioned about the outer surface of the lateral chamber wall 201 or the chamber closure 202. The fourth attachment mechanism 33 may be positioned about the inner surface of the lateral filter wall 301 or about the top edge of the lateral filter wall 301 opposite the filter closure 302, wherein the position of the fourth attachment mechanism 33 compliments the position of the third attachment mechanism 23 about the chamber body 20.

In reference to FIG. 12, in one embodiment of the present invention, the third attachment mechanism 23 and the fourth attachment mechanism 33 are a pair of opposing threads (i.e. one set of male threads and one set of female threads). The set of male threads can be formed by the third attachment mechanism 23, wherein the set of female threads is formed by the fourth attachment mechanism 33, or vice versa. In this way, the filter casing 30 is screwed onto the chamber body 20, wherein the filter casing 30 is securely held in place.

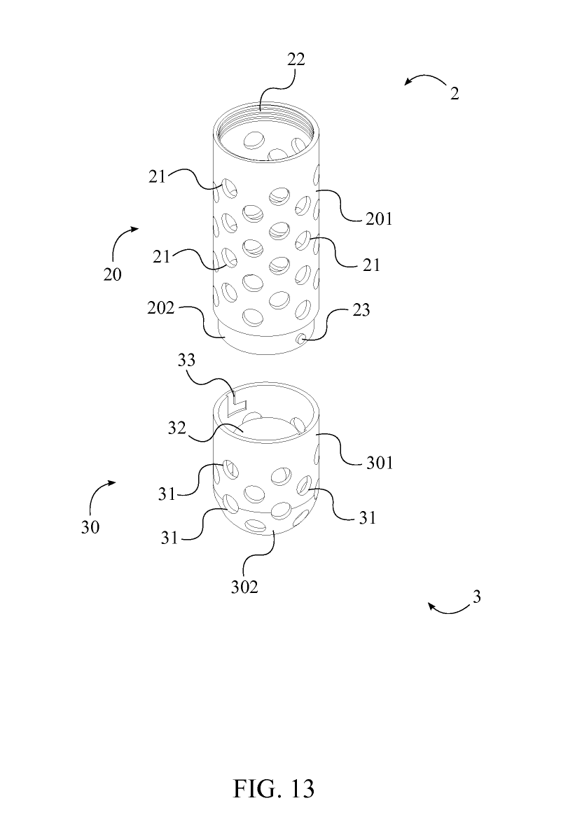

In reference to FIG. 13, in another embodiment of the present invention, the third attachment mechanism 23 and the fourth attachment mechanism 33 form a twist lock mechanism, wherein a catch pin and a twist lock groove are formed. The catch pin can be formed by the third attachment mechanism 23, wherein the twist lock groove is formed by the fourth attachment mechanism 33, or vice versa. In this way, the catch pin is slid into the twist lock groove and either the filter casing 30 or the chamber body 20 is rotated such that the catch pin follows the twist lock groove, thus securing the filter assembly 3 to the chamber body 20.

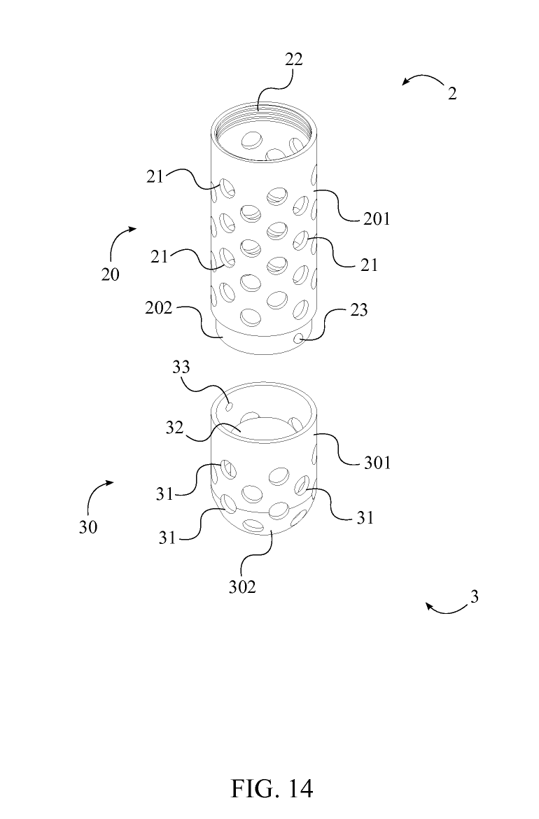

In reference to FIG. 14, in yet another embodiment of the present invention, the third attachment mechanism 23 and the fourth attachment mechanism 33 form a snap lock mechanism, wherein a catch pin and a snap indent are formed. The catch pin can be formed by the third attachment mechanism 23, wherein the snap indent is formed by the fourth attachment mechanism 33, or vice versa. In this way, as the filter casing 30 is pressed into the chamber body 20, the catch pin engages the snap indent, thus securely holding the filter casing 30 and the chamber body 20 together.

In the preferred embodiment of the present invention, the filter medium 32 is activated carbon. Activated carbon attracts impurities and contaminants such as chlorine and bisphenol A, the latter of which can be leaked from polycarbonate water bottles. The activated carbon works through the process of adsorption, wherein the impurities and contaminants are trapped in the molecular structure of the activated carbon. As the activated carbon has a finite lifetime, the filter medium 32 can be replaced when needed by detaching the filter casing 30 from the chamber body 20. It is also possible for the filter medium 32 to be comprised of any other material that is capable of passively filtering impurities and contaminants from water.

In the preferred embodiment of the present invention, the annular cap body 10 is secured to the water bottle by means of threading. The annular cap body 10 is internally threaded with a set of female threads that match the set of male threads of the water bottle. In this way, the annular cap body 10 is secured in place about the water bottle by screwing the annular cap body 10 onto the neck of the water bottle. The use of threading provides a secure means of attachment between the bottle dispensing cap 1 and the water bottle, however, the use of threading restricts the user with respect to using the present invention with water bottles having the same neck size.

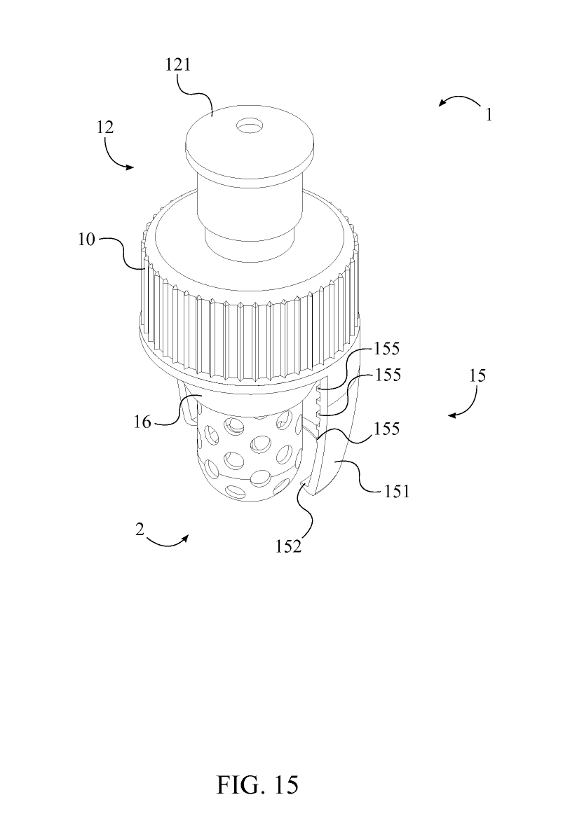

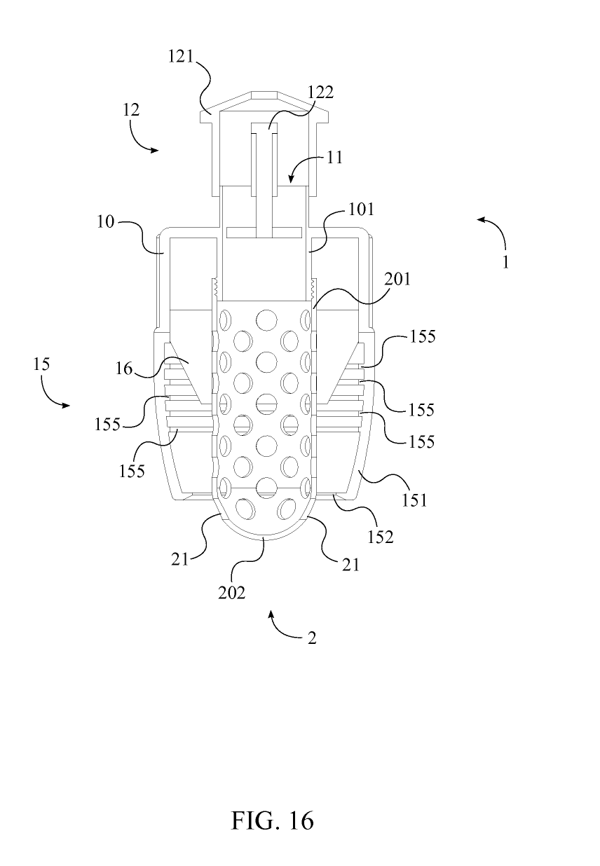

Therefore, in an alternative embodiment of the present invention, the bottle dispensing cap 1 further comprises a universal fitting clamp 15 and a cap seal 16. In reference to FIG. 15-16, both the universal fitting clamp 15 and the cap seal 16 are adjacently connected to the annular cap body 10 opposite the cap enclosure 12, wherein the universal fitting clamp 15 and the cap seal 16 extend downwards when the annular cap body 10 is upright. The cap seal 16 is concentrically positioned with the annular cap body 10 and has a central channel, such that the chamber body 20 centrally traverses through the cap seal 16, wherein the chamber body 20 and the spout 11 are in fluid communication with each other through the cap seal 16. When the annular cap body 10 is attached to the water bottle, the cap seal 16 is pressed against the top edge of the water bottle neck creating a water tight seal to prevent leaking. The cap seal 16 may also be conical, wherein the cap seal 16 is tapered away from the annular cap body 10 such that the cap seal 16 is partially inserted into the mouth of the water bottle.

In further reference to FIG. 15-16, the universal fitting clamp 15 is perimetrically positioned about the cap seal 16 and provides the means for attaching the bottle dispensing cap 1 to the water bottle. The universal fitting clamp comprises 15 a lateral clamp wall 151, a flange 152, and a plurality of extrusions 155. The lateral clamp wall 151 is adjacently connected to the annular cap body 10, while the flange 152 is adjacently connected to the lateral clamp wall 151 opposite the annular cap body 10 and extends inwards relative to the annular cap body 10. In one embodiment of the universal fitting clamp 15, the arc of the lateral clamp wall 151 is greater than or equal to half the circumference of the annular cap body 10. The lateral clamp wall 151 is flexible such that the lateral clamp wall 151 snaps around the neck of the water bottle, wherein the flange 152 engages underneath the lip of the water bottle, such that the bottle dispensing cap 1 cannot be pulled upwards to disengage the bottle dispensing cap 1 from the water bottle.

In another embodiment of the universal fitting clamp 15, the arc of the lateral clamp wall 151 is less than half the circumference of the annular cap body 10. Both the lateral clamp wall 151 and the flange 152 are flexible, wherein the flange 152 extends wider than the lateral clamp wall 151 in a circular formation. In this way, the lateral clamp wall 151 can be bent towards or away from the annular cap body, while the flange 152 snaps around the neck of the water bottle. The flange 152 snaps underneath the lip of the water bottle, such that the bottle dispensing cap 1 cannot be pulled upwards to disengage the bottle dispensing cap 1 from the water bottle.

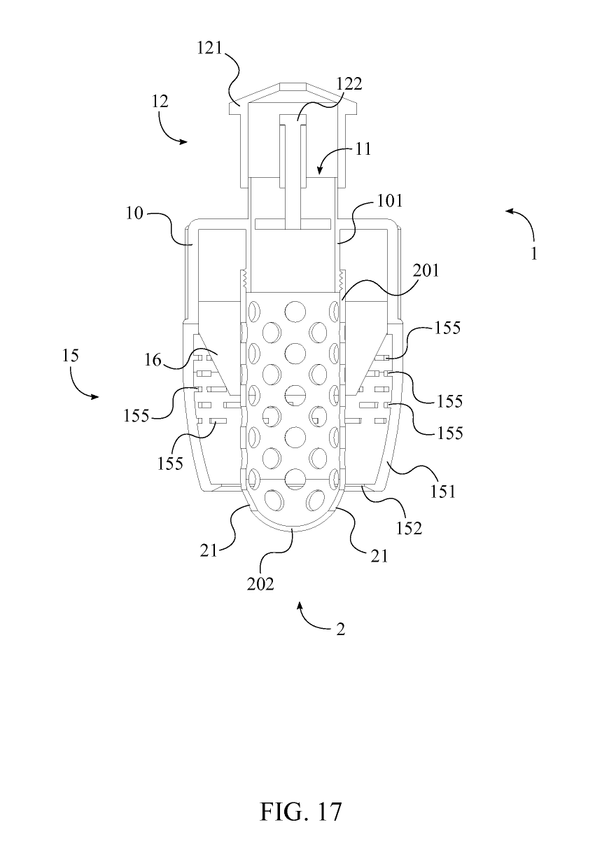

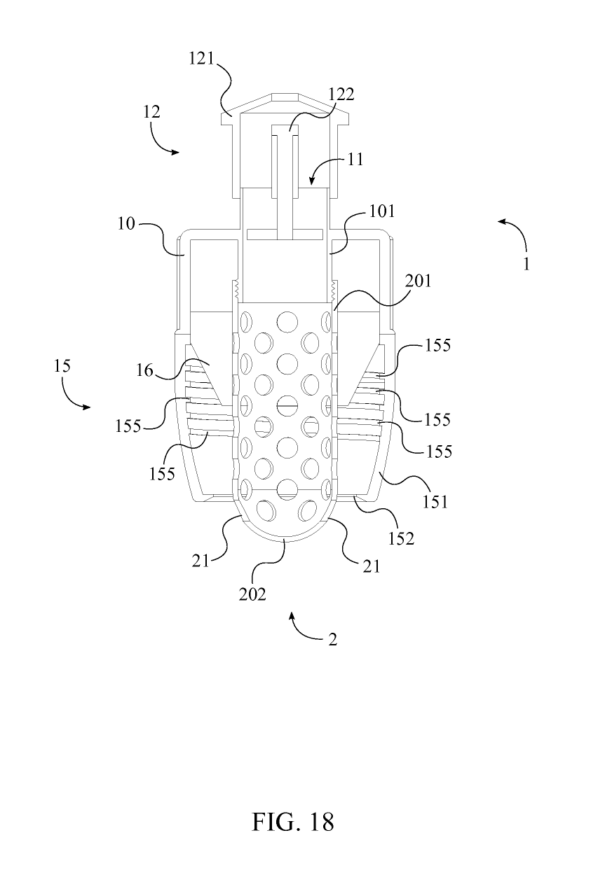

Each of the plurality of extrusions 155 is adjacently attached to the lateral clamp wall 151 in between the flange 152 and the annular cap body 10. The plurality of extrusions 155 engages the threaded portion of the water bottle in order to further secure the bottle dispensing cap 1 to the water bottle. The plurality of extrusions 155 can be configured in a number of ways in order to best engage the threaded portion of the water bottle. In one configuration, each of the plurality of extrusions 155 is a continuous horizontal rib that traverses about the arc of the lateral clamp wall 151 from end to end, as depicted in FIG. 16. In another configuration, each of the plurality of extrusions 155 is a smaller horizontal rib, wherein the plurality of extrusions 155 is staggered about the lateral clamp wall 151, as depicted in FIG. 17. In yet another configuration, each of the plurality of extrusions 155 is a continuous angled rib to match the threading of the water bottle, as depicted in FIG. 18.

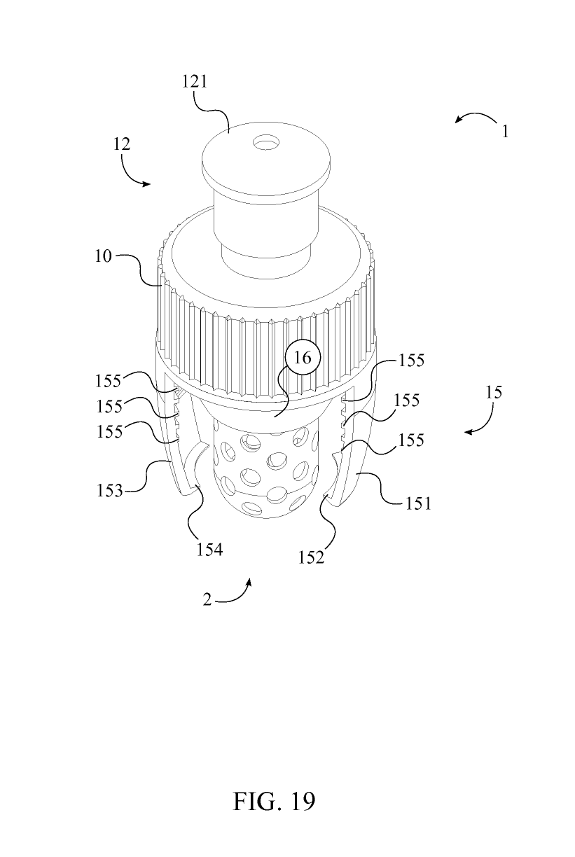

In reference to FIG. 19, in yet another embodiment of the universal fitting clamp 15, the universal fitting clamp further comprises a second lateral clamp wall 153 and a second flange 154. The second lateral clamp wall 153 is adjacently connected to the annular cap body 10 opposite the lateral clamp wall 151, wherein the arc of both the lateral clamp wall 151 and the second lateral clamp wall 153 is less than half the circumference of the annular cap body 10. The second flange 154 is adjacently connected to the second lateral clamp wall 153 opposite the annular cap body 10 and extends inwards relative to the annular cap body 10. The plurality of extrusions 155 is adjacently connected to lateral clamp wall 151 in between the flange 152 and the annular cap body 10 and adjacently connected to the second lateral clamp wall 153 in between the second flange 154 and the annular cap body 10. The plurality of extrusions can be arranged in any of the previously mentioned configurations.

It will be appreciated that embodiments of the present invention utilizing the universal fitting clamp 15 allow the present invention to be used without the cartridge chamber 2 as a universal bottle cap closure to prevent spills while keeping beverages fresh.

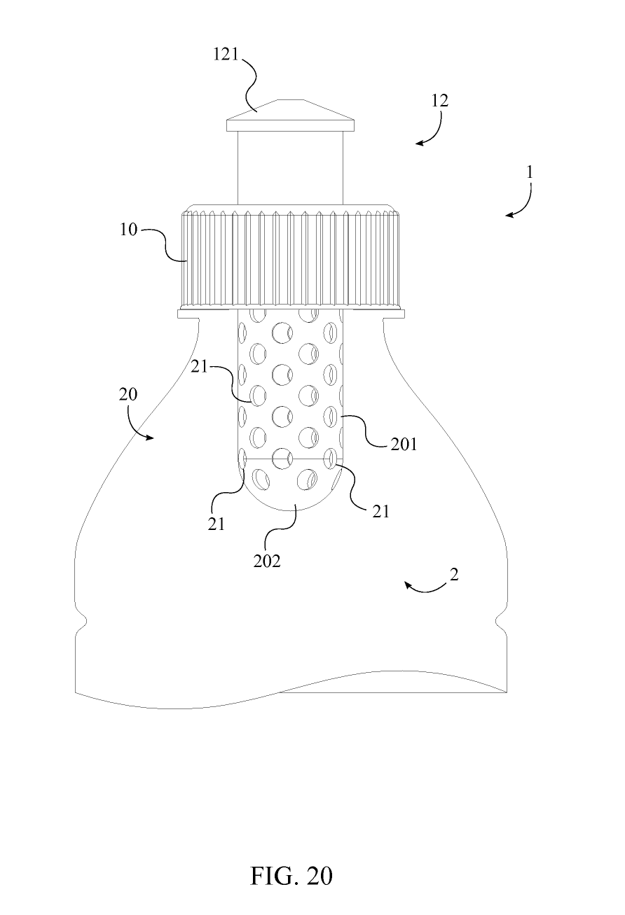

In order to use the present invention, the cartridge chamber 2 is first detached from the bottle dispensing cap 1. The soluble consumables chosen by the user are then loaded into the chamber body 20 and the cartridge chamber 2 is re-attached to the bottle dispensing cap 1. The filter casing 30, filled with the filter medium 32, is then attached to the chamber body 20 if the filter assembly 3 is utilized. The chamber body 20 (or the chamber body 20 and the filter assembly 3) is then inserted into the water bottle and the annular cap body 10 is attached to the water bottle either via the internal threading, as shown in FIG. 20, or the universal fitting clamp 15. The user then agitates the water bottle, wherein water flows through the plurality of perforations 21 and through the chamber body 20, wherein the soluble consumables are dissolved in the water. The water with the dissolved soluble consumables is then dispensed through the spout 11 when the cap enclosure 12 is opened.

Although the invention has been explained in relation to its preferred embodiment, it is to be understood that many other possible modifications and variations can be made without departing from the spirit and scope of the invention as hereinafter claimed.

What is claimed is:

1. A bottle cap dispenser comprises:
a bottle dispensing cap;
a cartridge chamber;
the bottle dispensing cap comprises an annular cap body, a spout, a cap closure, and a first attachment mechanism;
the cartridge chamber comprises a chamber body, a plurality of perforations, and a second attachment mechanism;
the spout being positioned through the annular cap body;
the cap closure being adjacently connected to the annular cap body;
the cap closure being positioned adjacent to the spout;
the first attachment mechanism being integrated into the annular cap body opposite the cap enclosure;
the plurality of perforations being positioned through the chamber body;
the second attachment mechanism being integrated into the chamber body;
the chamber body being adjacently attached to the annular cap body;
the second attachment mechanism engaging the first attachment mechanism; and
the spout being in fluid communication with the chamber body.

2. The bottle cap dispenser as claimed in claim 1 further comprises:
the annular cap body comprises a tubular extrusion;
the tubular extrusion being positioned within the annular cap body; and
the first attachment mechanism being integrated into the tubular extrusion.

3. The bottle cap dispenser as claimed in claim 1 further comprises:
the chamber body comprises a lateral chamber wall and a chamber closure;
the second attachment mechanism being integrated into the lateral chamber wall; and
the chamber closure being adjacently connected to the lateral chamber wall opposite the second attachment mechanism.

4. The bottle cap dispenser as claimed in claim 1 further comprises:
the cap enclosure comprises a cap shaft and a nozzle;
the cap shaft being adjacently connected to the annular cap body opposite the chamber body;
the cap shaft being positioned adjacent to the spout;
the nozzle being positioned adjacent to the annular cap body opposite the chamber body;
the nozzle being bistably connected to the cap shaft; and
the nozzle being in fluid communication with the spout.

5. The bottle cap dispenser as claimed in claim 1 further comprises:
the cap enclosure comprises a lid and a hinge;
the annular cap body comprises a screen;
the hinge being adjacently connected to the annular cap body;
the lid being adjacently connected to the hinge opposite the annular cap body; and
the screen being positioned within the annular cap body, wherein the screen is positioned within or adjacent to the spout.

6. The bottle cap dispenser as claimed in claim 1 further comprises:
the bottle dispensing cap further comprises a universal fitting clamp and a cap seal;
the universal fitting clamp and the cap seal being adjacently connected to the annular cap body opposite the cap enclosure;
the cap seal being concentrically positioned with the annular cap body, wherein the chamber body centrally traverses through the cap seal; and
the universal fitting clamp being perimetrically positioned about the cap seal.

7. The bottle cap dispenser as claimed in claim 6 further comprises:
the universal fitting clamp comprises a lateral clamp wall, a flange, and a plurality of extrusions;
the lateral clamp wall being adjacently connected to the annular cap body;
the flange being adjacently connected to the lateral clamp wall opposite the annular cap body; and
the plurality of extrusions being adjacently connected to the lateral clamp wall in between the flange and the annular cap body.

8. The bottle cap dispenser as claimed in claim 7 further comprises:
the universal fitting clamp further comprises a second lateral clamp wall and a second flange;
the second lateral clamp wall being adjacently connected to the annular cap body opposite the lateral clamp wall;
the second flange being adjacently connected to the second lateral clamp wall opposite the annular cap body; and
the plurality of extrusions being adjacently connected to the second lateral clamp wall in between the second flange and the annular cap body.

9. The bottle cap dispenser as claimed in claim 1 further comprises:
a filter assembly;
the filter assembly comprises a filter casing, a plurality of filter holes, and a filter medium;
the filter casing being adjacently attached to the chamber body opposite the annular cap body;
the plurality of filter holes being positioned through the filter casing; and
the filter medium being positioned within the filter casing.

10. The bottle cap dispenser as claimed in claim 9 further comprises:
the cartridge chamber further comprises a third attachment mechanism;
the filter assembly further comprises a fourth attachment mechanism;
the third attachment mechanism being integrated into the chamber body opposite the second attachment mechanism;
the fourth attachment mechanism being integrated into the filter casing; and
the fourth attachment mechanism engaging the third attachment mechanism.

11. The bottle cap dispenser as claimed in claim 10 further comprises:
the filter casing comprises a lateral filter wall and a filter closure;
the fourth attachment mechanism being integrated into the lateral filter wall; and
the filter closure being adjacently connected to the lateral filter wall opposite the fourth attachment mechanism.

12. A bottle cap dispenser comprises:
a bottle dispensing cap;
a cartridge chamber;
a filter assembly;
the bottle dispensing cap comprises an annular cap body, a spout, a cap enclosure, and a first attachment mechanism;
the cartridge chamber comprises a chamber body, a plurality of perforations, a second attachment mechanism, and a third attachment mechanism;
the filter assembly comprises a filter casing, a plurality of filter holes, a filter medium, and a fourth attachment mechanism;
the spout being positioned through the annular cap body;
the first attachment mechanism being integrated into the annular cap body;
the plurality of perforations being positioned through the chamber body;
the second attachment mechanism being integrated into the chamber body;
the third attachment mechanism being integrated into the chamber body opposite the second attachment mechanism;
the chamber body being adjacently attached to the annular cap body;
the second attachment mechanism engaging the first attachment mechanism;
the spout being in fluid communication with the chamber body;
the fourth attachment mechanism being integrated into the filter casing;
the filter casing being adjacently attached to the chamber body opposite the annular cap body;
the fourth attachment mechanism engaging the third attachment mechanism;
the plurality of filter holes being positioned through the filter casing; and
the filter medium being positioned within the filter casing.

13. The bottle cap dispenser as claimed in claim 12 further comprises:
the annular cap body comprises a tubular extrusion;
the tubular extrusion being positioned within the annular cap body; and
the first attachment mechanism being integrated into the tubular extrusion.

14. The bottle cap dispenser as claimed in claim 12 further comprises:
the chamber body comprises a lateral chamber wall and a chamber closure;
the second attachment mechanism being integrated into the lateral chamber wall; and
the chamber closure being adjacently connected to the lateral chamber wall opposite the second attachment mechanism.

15. The bottle cap dispenser as claimed in claim 12 further comprises:
the cap enclosure comprises a cap shaft and a nozzle;
the cap shaft being adjacently connected to the annular cap body opposite the chamber body;
the cap shaft being positioned adjacent to the spout;
the nozzle being positioned adjacent to the annular cap body opposite the chamber body;
the nozzle being bistably connected to the cap shaft; and
the nozzle being in fluid communication with the spout.

16. The bottle cap dispenser as claimed in claim 12 further comprises:
the cap enclosure comprises a lid and a hinge;
the annular cap body comprises a screen;
the hinge being adjacently connected to the annular cap body;
the lid being adjacently connected to the hinge opposite the annular cap body; and
the screen being positioned within the annular cap body, wherein the screen is positioned within or adjacent to the spout.

17. The bottle cap dispenser as claimed in claim 12 further comprises:
the bottle dispensing cap further comprises a universal fitting clamp and a cap seal;
the universal fitting clamp and the cap seal being adjacently connected to the annular cap body opposite the cap enclosure;
the cap seal being concentrically positioned with the annular cap body, wherein the chamber body centrally traverses through the cap seal; and
the universal fitting clamp being perimetrically positioned about the cap seal.

18. The bottle cap dispenser as claimed in claim 17 further comprises:
the universal fitting clamp comprises a lateral clamp wall, a flange, and a plurality of extrusions;
the lateral clamp wall being adjacently connected to the annular cap body;
the flange being adjacently connected to the lateral clamp wall opposite the annular cap body; and
the plurality of extrusions being adjacently connected to the lateral clamp wall in between the flange and the annular cap body.

19. The bottle cap dispenser as claimed in claim 18 further comprises:
the universal fitting clamp further comprises a second lateral clamp wall and a second flange;
the second lateral clamp wall being adjacently connected to the annular cap body opposite the lateral clamp wall;
the second flange being adjacently connected to the second lateral clamp wall opposite the annular cap body; and
the plurality of extrusions being adjacently connected to the second lateral clamp wall in between the second flange and the annular cap body.

20. The bottle cap dispenser as claimed in claim 12 further comprises:
the filter casing comprises a lateral filter wall and a filter closure;
the fourth attachment mechanism being integrated into the lateral filter wall; and
the filter closure being adjacently connected to the lateral filter wall opposite the fourth attachment mechanism.
